(19) United States
(12) Patent Application Publication
(10) Pub. No.: US 2009/0152301 A1
(43) Pub. Date: Jun. 18, 2009

(54) DISPENSER FOR SPIRITS

(76) Inventors: Remo Guerra, Borgo Maggiore (SM); Michael Mongelluzzo, Brooklyn, NY (US)

Correspondence Address: BROWDY AND NEIMARK, P.L.L.C.;624 NINTH STREET, NW, SUITE 300, WASHINGTON, DC, 20001-5303, US

(21) Appl. No.: 11/577,610

(22) PCT Filed: Oct. 19, 2005
(86) PCT No.: PCT/SM05/00002

§ 371 Date: Feb. 9, 2009

(30) Foreign Application Priority Data
Oct. 20, 2004 (EP) 04024894.0

(51) Int. Cl. B67D 5/62

(52) U.S. Cl. 222/146.6; 222/504

(57) ABSTRACT

A dispenser for spirits comprises at least one loose spirit container (1), container (1) cooling means (2) and spirit dispensing means (3), in which the cooling means (2) comprise a water and glycol solution circulating in a closed circuit (4). The water and glycol solution comprises a quantity of glycol equivalent to at least 20%, so that the freezing point of the solution is at temperatures below −10° C.

### TECHNICAL FIELD

The present invention relates to a dispenser for spirits, suitable for dispensing spirits at very low temperatures, even below 0° C.

### BACKGROUND ART

The equipment currently used to cool spirits and other drinks to very low temperatures may be of various types. For example, there are blast chillers, for wines or sparkling wines, which use jets of air or liquid solutions with a high glycol content. This substance has the property of significantly lowering the freezing point of water (50% solutions bring the freezing point to approximately −32° C.) and the bottles are stored in it. An example of this kind of equipment is described in patent application WO97/35155. However, in both cases the cooling action is applied to the bottle and not to the drink and, as a result, a special dispensing system is not used.

Therefore each time spirit is to be spilled in a glass it is necessary take the bottle from its seat, open it, spill the spirit and replace it. Similarly, there are refrigerated display cases, used for spirits, in which the bottles can be kept, then removed when needed.

For other types of drinks cooling coils are used, but these cannot be used for temperatures close to zero, since the liquids in them would freeze.

Other cooling equipment is described in U.S. Pat. No. 5,494,195 and U.S. Pat. No. 5,890,629: the former relating to a machine which houses a thermoelectric cooling unit, that operates according to the principle of Peltier cells; the latter, an apparatus in which the thermoelectric unit uses one or more thermocouples positioned between two conductor plates to cool (or heat) the drinks.

However, there are unwanted effects in these cases too: use of Peltier cells requires a high level of energy consumption and, above all, dispersal of the heat produced locally; on the other hand, the use of thermocouples does not allow temperatures below 0° C. to be reached.

### DISCLOSURE OF THE INVENTION

The aim of the present invention is, therefore, to overcome the aforementioned disadvantages.

This is achieved using a glycol solution, circulating in a closed circuit in which thermal dispersion has been minimised, a section of its path making contact with the containers in which the spirits accumulates.

The main advantage basically consists of the fact that arbitrary quantities of spirits can be directly dispensed at temperatures below 0° C., using a system which until now has only been used for drinks normally served at temperatures above 0° C. As a result, there is no need to use (and cool) the bottles in which the spirits are purchased.

Moreover, the problems of having to disperse significant amounts of heat and consuming large quantities of energy do not arise.

### BRIEF DESCRIPTION OF THE DRAWINGS

Other features and advantages of the invention are more clearly indicated in the detailed description which follows with reference to the accompanying drawings which illustrate a preferred non-restricting embodiment of it and in which:

FIG. 1 is a schematic perspective view of the invention with some parts cut away to better illustrate others;

FIG. 2 is a perspective view of the invention;

FIG. 3 is a front view of a portion of the invention, highlighting the inner structure;

FIGS. 4 and 5 are views of the invention according to cross-sections IV-IV and V-V illustrated in FIG. 3.

### DETAILED DESCRIPTION OF THE PREFERRED EMBODIMENTS OF THE INVENTION

As illustrated in the accompanying drawings, the invention relates to a dispenser for spirits, comprising at least one container (1) for loose spirit, container (1) cooling means (2) and spirit dispensing means (3). FIG. 2 illustrates how the dispenser (30) is set up to dispense two or more spirits, and therefore to comprise two or more loose spirit containers (1). These are made of conductive, food-safe material (in particular, for example, stainless steel) to promote cooling of the spirits contained in them.

The tanks (22) for the various types of spirits may be the same bottles in which the spirit is purchased, but obviously, unlike various known applications, these are neither cooled nor used to dispense the spirits in any way.

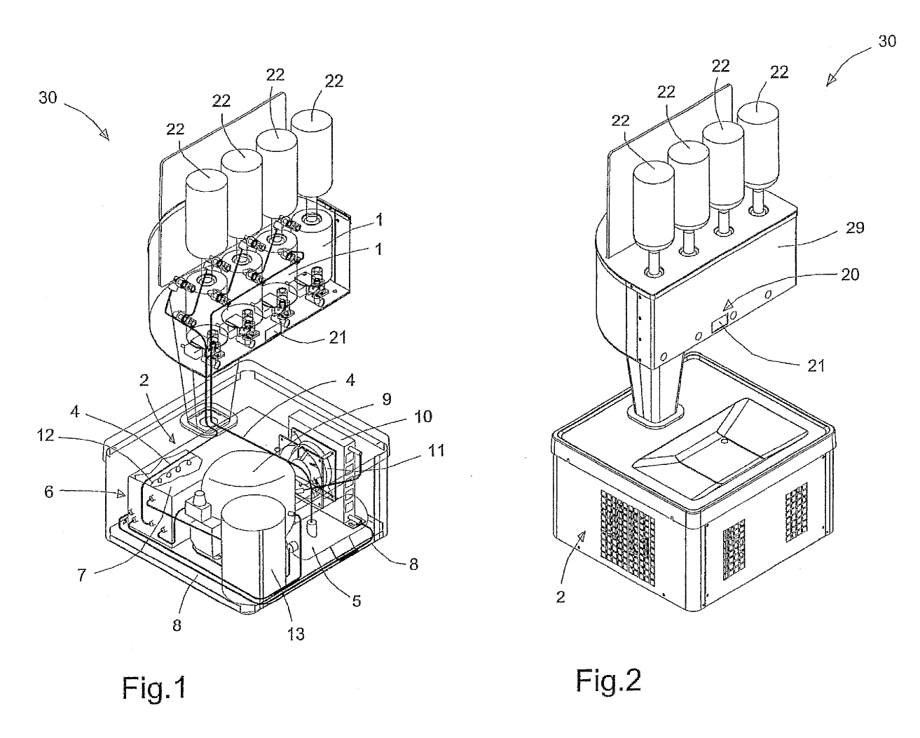

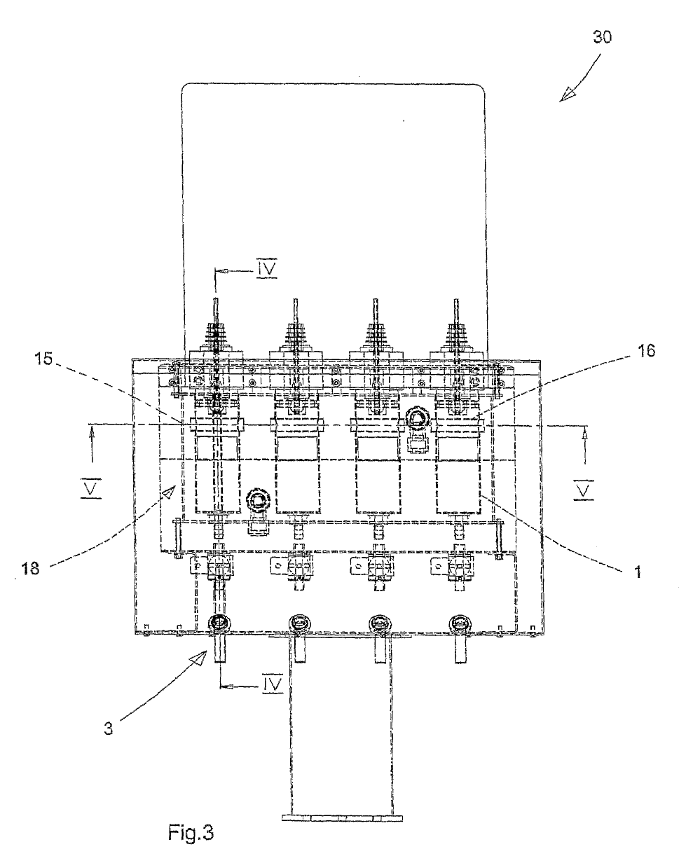

The cooling means (2), schematically illustrated in FIG. 1, comprise a solution of water and glycol circulating in a closed circuit (4). The water and glycol solution comprises a quantity of glycol equivalent to at least 20%, so that the freezing point of the solution is at temperatures below −10° C. In a preferred embodiment, the water and glycol solution comprises a quantity of glycol greater than 40%, so that it remains fluid even at temperatures below −20° C. Indeed, the presence of this substance in the solution used as a refrigerant allows it to be kept fluid to temperatures well below zero and make it circulate in the circuit (4) by means of a pump (5).

In practice, use of a magnetic drive pump (5) is preferred, so that the heat generated close to the pump (5) is not transferred to the glycol solution. In addition to the pump (5), designed to guarantee forced circulation of the glycol solution, the circuit (4) comprises at least one cooling station (6) for the glycol solution and, preferably, but not necessarily, a glycol solution tank (13), accessible from the outside to check the quantity of glycol solution circulating in the closed circuit (4). If necessary, this tank (13) can be worked on directly to top up the glycol solution and to check its fluidity.

The cooling station (6) comprises a heat exchanger (7), designed to make the glycol solution interact with a cooling circuit (8). The cooling circuit (8) comprises, in series, a compressor (9), a condenser (10) with a fan (11), and a coil (12) which acts as an evaporator submerged in the glycol solution in the heat exchanger (7). The cooling circuit (8) uses Freon as a refrigerant, for example, in particular, the compound known as HFC134A.

Following the path of the glycol solution from the cooling station (6), from which it comes out at temperatures below −20° C., it may be seen that it reaches the tank (13) then the pump (5), from which it is sent towards the loose spirit containers (1). Along the circuit (4) there is a submerging basin (15), filled with the glycol solution delivered by the pump (5), in which the loose spirit containers (1) are submerged. To maximise spirit cooling, the closed circuit (4) also comprises at least one open tube (16), housed in the submerging basin (15), which passes through at least one loose spirit container (1). In the embodiment illustrated, as shown in FIG. 5, each container (1) has an open tube (16) passing through it, located below the spirit infeed section and fixed in a sealed fashion to the walls of the container (1). In this way, when the spirit drops from its tank (22) into the corresponding container (1), it strikes the open tube (16), through it the water and glycol solution travels. The same solution fills the submerging basin (15) in which the loose spirit containers (1) are located, and the spirit dropping from the tank (22) is instantly subject to a first reduction in its temperature. Moreover, the interaction produces a spirit mixing effect, rendering its temperature uniform, which is desirable considering that at such low temperatures there is a significant tendency towards immobility.

The submerging basin (15) has an overflow (17), designed to help the glycol solution to flow out. Thus, after cooling the loose spirit containers (1), it returns to the cooling station (6).

A layer (18) of insulating material completely envelops the submerging basin (15), to minimise thermal dispersion and increase the efficiency of the entire equipment.

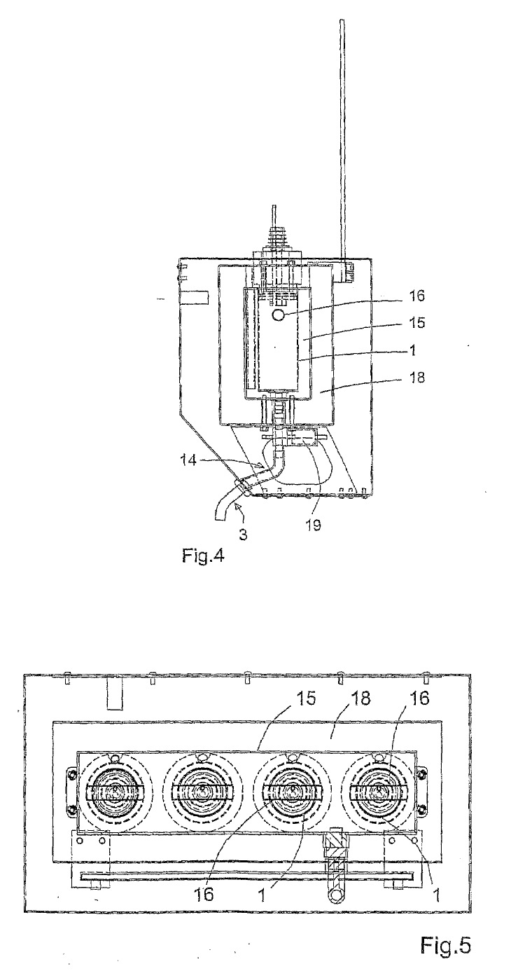

The spirit dispensing means (3), illustrated in FIG. 4, comprise an outlet tube (14), an electromagnetic valve (19) and means (20) which activate the electromagnetic valve (19), consisting of a push-button (21) located on a wall (29) of the dispenser (30). Advantageously, the outlet tube (14) is quite short so that the spirit travels a short distance after coming out of its container (1): both so that it does not heat up along said distance, and so that it does not stagnate in the tube (14). To prevent the latter disadvantage, activation of the electromagnetic valve (19) allows the outlet tube (14) to be filled with the quantity of spirit sufficient for one glass, which then moves downward under the effect of gravity.

The invention described may be subject to modifications and variations without thereby departing from the scope of the inventive concept. Moreover, all details of the invention may be substituted by technically equivalent elements.

In practice, obviously changes and/or improvements are possible which are covered by the claims herein.

1. A dispenser for spirits, comprising
at least a melted spirit container (1),
container cooling means (2), constituted by a water and glycol solution circulating in a closed circuit (4), and
spirit dispensing means (3),
characterised in that
the water and glycol solution is at a temperature below 0° C. and
the container (1) and dispensing means (3) are communicating to each other so that, at dispensing moment, the melted spirit directly goes from the container (1) to dispensing means (3) keeping the same temperature which the spirit has in the container (1),
said dispensing means (3) comprising measuring means (14,19) able to dispense single-dose quantities of spirit.

2. The dispenser according to claim 1, characterised in that the containers (1) are made of conductive food-safe material, promoting cooling of the spirit contained in them.

3. The dispenser according to claim 1, characterised in that the water and glycol solution comprises a quantity of glycol equivalent to at least 20%, so that the freezing point of the solution is at temperatures below −10° C.

4. The dispenser according to claim 1, characterised in that the closed circuit (4) comprises at least a pump (5), adapted to guarantee forced circulation of the glycol solution, and a glycol solution cooling station (6).

5. The dispenser according to claim 4, characterised in that the closed circuit (4) comprises a tank (13) of glycol solution, accessible from the outside to check the quantity of glycol solution circulating in the closed circuit (4).

6. The dispenser according to claim 4, characterised in that the closed circuit (4) comprises a submerging basin (15), filled with the glycol solution delivered by the pump (5), in which the loose spirit containers (1) are submerged.

7. The dispenser according to claim 6, characterised in that the closed circuit (4) also comprises at least one open tube (16), housed in the submerging basin (15), designed to pass through at least one loose spirit container (1).

8. The dispenser according to claim 6, characterised in that the submerging basin (15) comprises an overflow (17), adapted to help the glycol solution flow out.

9. The dispenser according to claim 6, characterised in that it comprises a layer (18) of insulating material, capable of completely enveloping the submerging basin (15).

10. The dispenser according to claim 4, characterised in that the pump (5) is a magnetic drive pump, so that the heat generated close to the pump (5) is not transferred to the glycol solution.

11. The dispenser according to claim 4, characterised in that the cooling station (6) comprises a heat exchanger (7), capable of making the glycol solution interact with a cooling circuit (8).

12. The dispenser according to claim 11, characterised in that the cooling circuit (8) comprises, in series, a compressor (9), a condenser (10) with a fan (11), a coil (12) acting as an evaporator submerged in the glycol solution in the heat exchanger (7).

13. The dispenser according to claim 11, characterised in that the cooling circuit (8) uses Freon as the refrigerant.

14. The dispenser according to claim 1, characterised in that the spirit dispensing means (3) comprise an outlet tube (14), an electromagnetic valve (19) and means (20) for activating the electromagnetic valve (19).

15. The dispenser according to claim 14, characterised in that the means (20) for activating the electromagnetic valve (19) comprise a push-button (21).

16. The dispenser according to claim 14, characterised in that activation of the electromagnetic valve (19) allows the outlet tube (14) to be filled with the quantity of spirit for one glass.
